(19) United States
(12) Patent Application Publication
(10) Pub. No.: US 2026/0088616 A1
(43) Pub. Date: Mar. 26, 2026

(54) Energy Management System and Method

(71) Applicant: Siemens Schweiz AG, Zürich (CH)

(72) Inventors: Sebastian Thiem, Neustadt an der Aisch (DE); Thomas Schütz, Fürth (DE); Alexander Heinisch, Kreuzstetten (AT); Hanspeter Schmutz, Zürich, ZH (CH); Martin Stoffel, Rudolfstetten (CH); Diego Cattaneo, Adliswil (CH); Nazanin Azari, Zuerich (CH); Parandaman Cadirvelou, Ormoy (FR); Tim Lukas Kömpf, Klingenberg am Main (DE)

(73) Assignee: Siemens Schweiz AG, Zürich (CH)

(21) Appl. No.: 19/112,367

(22) PCT Filed: Aug. 21, 2023
(86) PCT No.: PCT/EP2023/072941

§ 371 Date: Mar. 17, 2025

(30) Foreign Application Priority Data
Sep. 16, 2022 (EP) 22196017.2

(51) Int. Cl. H02J 3/00; H02J 3/14; H02J 3/28

(52) U.S. Cl. CPC H02J 3/003; H02J 3/004; H02J 3/14; H02J 3/28; H02J 7/82; H02J 2103/30; H02J 2103/40; H02J 2103/50; H02J 2105/12

(57) ABSTRACT

Various embodiments of the teachings herein include an energy management system for a building having power consumption devices, power generation devices, and power storage devices. An example includes: a monitoring unit to acquire information about power generated by the power generation devices, about power consumed by the power consumption devices, and about a respective state of charge of the power storage devices; a management unit to derive information about a flexibility of the power demand of the power consumption devices deployed in the building based on the information acquired by the monitoring unit; and an optimization unit to optimize the power allocation of the power produced by the power generation devices to the power consumption devices and/or to the power storage devices based at least in part on the derived flexibility information of the power demand.

### CROSS-REFERENCE TO RELATED APPLICATIONS

This application is a U.S. National Stage Application of International Application No. PCT/EP2023/072941 filed Aug. 21, 2023, which designates the United States of America, and claims priority to EP Application No. 22196017.2 filed Sep. 16, 2022, the contents of which are hereby incorporated by reference in their entirety.

### TECHNICAL FIELD

The present disclosure relates to energy management. Various embodiments of the teachings herein include systems and/or methods managing energy in buildings. In particular, some embodiments include energy management systems where demand-side flexibility has been unlocked.

### BACKGROUND

The energy sector is evolving into a model where decarbonisation is one of the prime goals. This is implemented mostly through an increase in electrification and a higher presence of renewable energy sources. This transformation of the energy sector brings along at least two important issues. First, the increase of renewable energies as sources of energy production introduces an element of variability in the grid, which must be compensated for to keep the required standards of reliability of the service. Second, the increasing electrification can lead to increases in the power demand, which again must be mitigated for the grid to avoid peak loads as much as possible.

The need for supply-side flexibility has been long recognized and implemented, but it requires more and more support with demand-side flexibility. Demand-side flexibility is defined as the portion of the demand that can either be modified (increased or decreased) or shifted. Demand-side flexibility measures have been traditionally articulated through demand response programs, which involve curtailments or load shedding during peak load times.

Energy management systems on the demand side, or demand-side energy management systems implement information and communication technologies in order to monitor an energy system (e.g. a building), model their different energy assets and optimize their energy usage. Demand side energy management systems are useful for managing the energy resources within demand response programs, but they can also be used in a broader sense.

The optimization process carried out by conventional energy management systems takes into account the supply-side resources as well as the storage assets of the energy system. Additionally, in most of the cases, actions to be taken on the demand side are limited to the curtailment or load shedding during peak demand times.

### SUMMARY

Teachings of the present disclosure may provide an improved energy management system for buildings, where the energy resources of the building are efficiently used by involving the demand-side flexibility into the optimization process. For example, some embodiments include an energy management system (100) for a building (B) having power consumption devices (L), power generation devices (G) and power storage devices (A), said system (100) comprising: a monitoring unit (10), which is configured to acquire information about the power generated by the power generation devices (G), about the power consumed by the power consumption devices (L) and about the state of charge of the power storage devices (A) ; a management unit (20), which is configured to derive information about a flexibility of the power demand of the power consumption devices (L) deployed in the building (B) based on the information acquired by the monitoring unit (10); and an optimization unit (30), which is configured to optimize the power allocation of the power produced by the power generation devices (G) to the power consumption devices (L) and/or to the power storage devices (A) depending on the derived flexibility information of the power demand.

In some embodiments, the optimization unit (30) is further configured to send request signals to the management unit (20), wherein the request signals are based on the optimized power allocation.

In some embodiments, the management unit (20) further comprises a load controlling subunit (40), configured to release an actuation signal(S) based on a received request signal to a set of actuators deployed at the site of the building (B).

In some embodiments, the management unit (20) is further configured to implement a default operation mode, which is defined by a set of predetermined values of power consumption and power generation of the building (B).

In some embodiments, the management unit (20) is further adapted to set a minimum waiting time (Tmin), during which the optimization unit (30) does not send request signals and the energy management system (100) runs under the default operation mode.

In some embodiments, the management unit (20) is further adapted to set a maximum flexibility use time (Tmax) for the optimization unit (30) to operate without interruption.

In some embodiments, the management unit (20) is further configured to switch to the default operation mode, when the maximum flexibility use time (Tmax) of operation of the optimization unit (30) has expired.

In some embodiments, the optimization unit (30) is adapted to implement an energy data model of the building (B) and an optimization algorithm, wherein the data model is adapted to use forecasts of the power generation and forecasts of the power demand of the building (B) as well as the acquired data as input.

In some embodiments, the optimization algorithm is further configured to use as input information at least a weather forecast (W) and/or an information about the power supplied by a power supply grid providing electrical energy to the building.

In some embodiments, the optimization unit (30) further comprises a database unit (65), which is configured to store a base load time series of the building, and wherein the optimization algorithm is further configured to retrieve the base load time series and use it as input.

In some embodiments, the management unit (20) and/or the optimization unit (30) are implemented in a server or as part of a cloud platform.

In some embodiments, the optimization unit (30) is further configured to request the derived information about the flexibility of the power demand no more often than every 10 seconds, or every 5 seconds.

In some embodiments, the flexibility of the power demand is communicated to the optimization unit (30) in an aggregated way, and wherein the optimization unit (30) is adapted to model the flexibility of the power demand as a virtual battery.

As another example, some embodiments include a computer-implemented energy management method (M) for a building (B), comprising: acquiring (M1) information about the power generated by the power generation devices (G), about the power consumed by the power consumption devices (L) and about the state of charge of the power storage devices (A) ; deriving (M2), based on the acquired information, information about a flexibility of the power demand of the power consumption devices (L) deployed in the building; and optimizing (M3) the power allocation of the power produced by the power generation devices (G) to the power consumption devices (L) and/or to the power storage devices (A) depending on the derived flexibility information of the power demand.

As another example, some embodiments include ea computer program product (300) comprising executable program code (350), which is configured, when executed, to perform one or more of the computer-implemented methods described herein.

As another example, some embodiments include a non-transient computer-readable data storage medium (400) comprising executable program code (450), which is configured, when executed, to perform one or more of the computer-implemented methods described herein.

### BRIEF DESCRIPTION OF THE DRAWINGS

Aspects of the present disclosure will be better understood with reference to the following figures. In the figures:

FIG. 1 is a schematic depiction of an energy management system for a building incorporating teachings of the present disclosure;

FIG. 2 is a schematic representation of the flexibility of the power demand and the flexibility of the power generation;

FIG. 3 is a block diagram showing an exemplary embodiment of a computer-implemented energy management system method (M) incorporating teachings of the present disclosure;

FIG. 4 is an exemplary illustration of the basic principle of the present invention on a plot showing the evolution of the power consumption charge (PCC) of a building with time;

FIG. 5 shows a description of the features of the management unit and the optimization unit incorporating teachings of the present disclosure;

FIG. 6 shows a possible data point of the management unit in an end-user interface incorporating teachings of the present disclosure;

FIG. 7 is a table showing one exemplary illustration of the interaction between the management unit and the optimization unit upon the generation of a set of request signals incorporating teachings of the present disclosure;

FIG. 8 is a table showing another exemplary illustration of the interaction between the management unit and the optimization unit upon the generation of another set of request signals incorporating teachings of the present disclosure;

FIG. 9 is a schematic block diagram illustrating a computer program product incorporating teachings 4 the present disclosure; and

FIG. 10 is a schematic block diagram illustrating a non-transitory computer-readable data storage medium incorporating teachings of the present disclosure.

### DETAILED DESCRIPTION

Some embodiments of the teachings herein include an energy management system for a building having power consumption devices, power generation devices and power storage devices, said system comprising: a monitoring unit, which is configured to acquire information about power generated by the power generation devices, about power consumed by the power consumption devices and about the state of charge of the power storage devices; a management unit, which is configured to derive information about a flexibility of the power demand of the power consumption devices deployed in the building based on the information acquired by the monitoring unit; and an optimization unit, which is configured to optimize the power allocation of the power produced by the power generation devices to the power consumption devices and/or to the power storage devices depending on the derived flexibility information of the power demand.

A building will be henceforth understood broadly as an energy system, belonging either to the industrial, commercial or residential sectors, that has an energy demand and a number of resources or assets with which it is able to generate and store energy. The building contains a number of energy loads that consume energy. The required energy can be supplied to the building as electrical energy by a public or by a local power supply grid and/or can be provided through heat pumps or combined heat and power (CHP) devices and/or can come from onsite power generation (e.g. from solar panels) at the site of the building and/or also from a number of storage assets (e.g. batteries, thermal energy storages) deployed at the site of the respective building. Here and in the following, when it is referred to energy generation, onsite energy generation as well as the energy supplied by the grid is considered.

The flexibility of the power demand, i.e. the demand-side flexibility, may be defined as the admissible increase or admissible decrease of the power demand that can be performed, e.g. in a specific building through the management of its loads or power-consuming devices. For example, if a certain task or energy consuming operation inside the building can be shifted to a later time, this adds to the demand-side flexibility of the building. Heating, ventilation and air conditioning (HVAC) systems and air-handling units are examples of loads or power-consuming systems which provide demand-side flexibility.

The monitoring unit used in the energy management system is an information and communication technology device capable of acquiring data and delivering it for further processing. The monitoring unit can be connected to a set of sensor units of different kinds, and it is configured to acquire information, about the consumption of the loads deployed at the site of the building, the state of charge (SoC) of the storage assets and the amount of o energy produced locally at the site of the building (e.g. by a photovoltaic installation) or by the grid. The monitoring unit may be realized in hardware and/or software, cable-bound and/or wireless, and in any combination thereof. It can comprise an interface to an intranet or to the Internet, to a cloud computing service, to a remote server and/or the like.

The management unit and optimization unit as used in the energy management system are broadly understood as entities able to process information. Each of them may therefore contain, at least, a central processing unit, CPU, and/or at least one graphics processing unit, GPU, and/or at least one field-programmable gate array, FPGA, and/or at least one application-specific integrated circuit, ASIC and/or any combination of the foregoing. Each of them may further comprise a working memory operatively connected to the at least one CPU and/or a non-transitory memory operatively connected to the at least one CPU and/or the working memory. Each of them may be configured to implement software or applications to execute programs. Each of them may be implemented partially and/or completely in a local apparatus (e.g. a cell phone or another portable user equipment) and/or partially and/or completely in a remote system such as a cloud computing platform. They may be realized in hardware and/or software, cable-bound and/or wireless, and in any combination thereof. Each of them may comprise an interface to an intranet or the Internet, to a cloud computing service, to a remote server and/or the like.

As another example, some embodiments include a computer-implemented energy management method for a building, comprising: (a) acquiring information about the power generated by the power generation devices, about the power consumed by the power consumption devices and about the state of charge of the power storage devices; (b) deriving, based on the acquired information, information about a flexibility of the power demand of the power consumption devices deployed in the building; and (c) optimizing the power allocation of the power produced by the power generation devices to the power consumption devices and/or to the power storage devices depending on the derived flexibility information of the power demand.

In particular, the methods described herein may be carried out by the systems described herein. The features and advantages disclosed herein in connection with the energy management system are therefore also disclosed for the method, and vice versa.

As another example, some embodiments include a computer program product comprising executable program code configured to, when executed, perform one or more of the methods described herein.

As another example, some embodiments include a non-transient computer-readable data storage medium comprising executable program code configured to, when executed, perform one or more of the methods described herein. The non-transient computer-readable data storage medium may comprise, or consist of, any type of computer memory, in particular semiconductor memory such as a solid-state memory. The data storage medium may also comprise, or consist of, a CD, a DVD, a Blu-Ray-Disc, a USB memory stick or the like.

As another example, some embodiments include a data stream comprising, or configured to generate, executable program code configured to, when executed, perform one or more of the methods described herein.

Some of the embodiments include an energy management system that incorporates demand-side 1 into the energy strategy planning of a building. Information about the power generation, power consumption and state of charge of the storage assets of the building is gathered by a monitoring device through a number of sensors located at different points in the building, i.e. within the closed inner space of the building but also at other points at the site of the building, e.g. at the roof of the building. This information is processed by a management unit, which is adapted to determine the demand-side flexibility of the building at any point in time. An optimization unit is adapted to use the demand-side flexibility to determine an optimized use of the energy of the building by allocating the power produced by the power generation devices to the power consumption devices and/or to the power storage devices.

In other words, the optimization unit of the energy management system determines when to optimally use the demand-side flexibility, e.g. in periods where the onsite generation of energy is low, such as at times where cloudy skies are forecasted and generation of solar power by the local power generation devices of the building is diminished.

The systems as described above allow a simple implementation of a computer-implemented energy management method. In a first step, information about the power status of the building (power consumption, power generation and state of charge SoC of the energy storage devices) is collected. In a further step, this information is processed to generate information about the demand-side flexibility of the building over time. The information about the demand-side flexibility is then subsequently used to find an optimal allocation of the energy resources of the building.

The systems and methods described herein may determine and exploit the demand-side flexibility of a building to generate an optimized use of the energy assets of the building. This leads in particular to a more efficient energy management of the building, without interfering with the normal operations of the building or generating discomfort for its occupants. By unfolding and using the demand-side flexibility, a high level of renewable energy resources in the building can be allocated, with the corresponding benefits towards decarbonization.

The energy management system may be updated with a high frequency, which on the one hand leads to a reduction of peak loads, and on the other hand helps counter the effects of unexpected events, e.g. sudden changes in the energy supply from the power supply grid or sudden changes in the meteorological conditions in the local environment of the building.

In some embodiments, the optimization unit of the energy management system is further configured to send request signals to the management unit, wherein the request signals are based on the optimized power allocation. In other words, the management unit of the energy management system can process the information generated by the optimization unit and can form signals provided to request changes in the energy settings of the building. In some of the preferred embodiments, the energy settings of the building can be modified periodically, e.g. every minute, which increases the resilience of the energy management system of the invention against unexpected and sudden changes.

In some embodiments, the management unit of the energy management system further comprises a load controlling subunit, configured to release an actuation signal based on a received request signal to a set of actuators deployed at the site of the building. A load controlling subunit is to be understood as any device or collection of devices able to release signals to a set of actuators, for them to perform an operation or mechanical function adapted to change the energetic configuration of the building according to the request signal. For instance, a set of actuators may comprise different mechanisms that activate air-conditioning valves, or electric roller shutters.

In some embodiments, the management unit of the energy management system is further configured to implement a default operation mode, which is defined by a set of predetermined values of power consumption and power generation of the building. These values can be taken from past records of the building energy management or be simply some prescribed values.

In some embodiments, the management unit the energy management system is further adapted to set a minimum waiting time, during which the optimization unit does not send requests signals and the energy management system runs under the default operation mode. The use of the demand-side flexibility can only be done for a limited period of time. A minimum waiting time before the flexibility can be used anew is therefore needed. This minimum waiting time can be set manually by a user through a user interface. The minimum waiting time can be set to a default value or be changed, for instance by filling a query command prompted by the management unit in the user interface. The minimum waiting time may also be automatically set by the system based on the time that it takes to bring the entire building back to default operation mode.

In some embodiments, the management unit of the energy management system is further adapted to set a maximum flexibility use time for the optimization unit to operate without interruption. This maximum flexibility use time limits the cyclic operation of the optimization unit. If the maximum flexibility use time is set to zero, the optimization unit is effectively switched off. This maximum flexibility use time, just like the minimum waiting time mentioned above, can be set by a user and modified anytime, e.g. through a query command prompted by the management unit in the user interface. In some embodiments, the maximum flexibility use time may be automatically set by the system.

The request signals can therefore be distributed in cycles, which are constrained by a minimum waiting time and by a maximum flexibility use time, which can be both modified by a user or set automatically by the system.

In some embodiments, the management unit of the energy management system is further configured to switch to the default operation mode, when the maximum flexibility use time of operation of the optimization unit has expired. This automatic transition to the default operation mode has the advantage that the demand-side flexibility may be automatically regenerated right after the optimization unit of the energy management system has completed a cycle of operation.

In some embodiments, the optimization unit of the energy management system is adapted to implement an energy data model of the building and an optimization algorithm, wherein the data model is adapted to use forecasts of the power generation and forecasts of the power demand of the building as well as the acquired data as input. The energy data model of the building takes into account the different energy resources of the building (energy storage assets and energy generation assets) as well as the power demand, which is evaluated for all the energy loads. The optimization proceeds by using the present power configuration of the building and projecting it onto the future on the basis of the forecasts, wherein the projections can be based e.g. on a past evolution of the power configuration of the building over time.

In some embodiments, the optimization algorithm is further configured to use as input information at least a weather forecast and/or an information about the power supplied by a power supply grid providing electrical energy to the building. The weather forecast is an important input to predict a future performance of the renewable energy assets (e.g. solar panels and wind power units) of the respective building. An information about the power supplied by the grid can refer, e.g., to possible reductions of the supplied power, such as the ones implemented in some demand response programs. It may also indicate the supply-side flexibility coming from the grid.

In some embodiments, the optimization unit of the energy management system further comprises a database unit, which is configured to store a base load time series of the building, and wherein the optimization algorithm is further configured to retrieve the base load time series and use it as input. The base load indicates the minimum level of power demand required to operate the building over 24 hours and forms a useful reference for load forecasting. The base load takes into account e.g. continuous loads like servers deployed at the site of the building or heating/cooling devices provided to keep a comfort temperature in the building. In other words, the base load of the building indicates the power consumption of all non-steerable loads at the site of the building. The base load time series is computed, e.g. by the optimization unit, by taking the measured base load time series and subtracting from it the used flexibility. Both the measured base load time series and the used flexibility are determined by the management unit. With this subtraction, the base load time series (without any flexibility action) can be derived.

In some embodiments, the management unit and/or the optimization unit of the energy management system are implemented in a server or as part of a cloud platform. In huge buildings, where the energy management is complex, it is advantageous to have the information as decentralized and as available as possible. Particularly in huge buildings, different individuals might be responsible for different aspects of energy management and they should have simultaneous access to the information provided by the energy management systems described herein.

In some embodiments, the optimization unit of the energy management system is further configured to request the derived information about the flexibility of the power demand no more often than every 10 seconds, or every 5 seconds. The optimized power configuration can thereby be updated almost in real-time.

In some embodiments, the flexibility of the power demand is communicated to the optimization unit of the energy management system in an aggregated way, and the optimization unit is adapted to model the flexibility of the power demand as a virtual battery. By communicating the demand-side flexibility as a total value that aggregates the demand-side flexibility of all loads in the building saves a lot of computational effort to the optimization unit. As a consequence, it is not necessary for the optimization unit to integrate information about all the individual demand-side assets. Instead, the demand-side flexibility of the building as a whole is modelled as a virtual power storage unit, with a capacity given by the demand-side flexibility integrated over the maximum time of use of the flexibility. This virtual battery, much as a real battery, can be charged and discharged, and it is easy to implement into the optimization algorithm.

Although here, in the foregoing and also in the following, some functions are described as being performed by units, it shall be understood that this does not necessarily mean that such units are provided as entities separate from one another. In cases where one or more units are provided as software, the units may be implemented by program code sections or program code snippets, which may be distinct from one another but which may also be interwoven or integrated into one another. Similarly, in cases where one or more units are provided as hardware, the functions of one or more units may be provided by one and the same hardware component, or the functions of several units may be distributed over several hardware components, which need not necessarily correspond to the units. Thus, any device, system or method which exhibits all of the features and functions ascribed to a specific unit shall be understood to comprise, or implement, said unit. In particular, it is a possibility that all units are implemented by program code executed by the computing device, for example by a server or by a cloud computing platform.

The above embodiments and implementations can be combined with each other as desired, as far as this is reasonable.

Further scope of the applicability of the present method and system will become apparent from the following figures, detailed description and claims. However, it should be understood that the detailed description and specific examples are given by way of illustration only, since various changes and modifications within the spirit and scope of the disclosure will become apparent to those skilled in the art. Parts in the different figures that correspond to the same elements have been tagged with the same reference numerals.

The components illustrated in the figures are not necessarily to scale, emphasis being placed instead upon clearly illustrating the principles of the present disclosure. Likewise, certain components can be shown in generalized or schematic form in the interest of clarity and conciseness. In some instances, well-known structures and devices are shown in block diagram form in order to avoid obscuring the concepts. The numeration of the steps in the methods are meant to ease their description. They do not necessarily imply a certain ordering of the steps. In particular, several steps may be performed concurrently. The detailed description includes specific details for the purpose of providing a thorough understanding of the present disclosure. However, it will be apparent to those skilled in the art that the present teachings may be practised without these specific details.

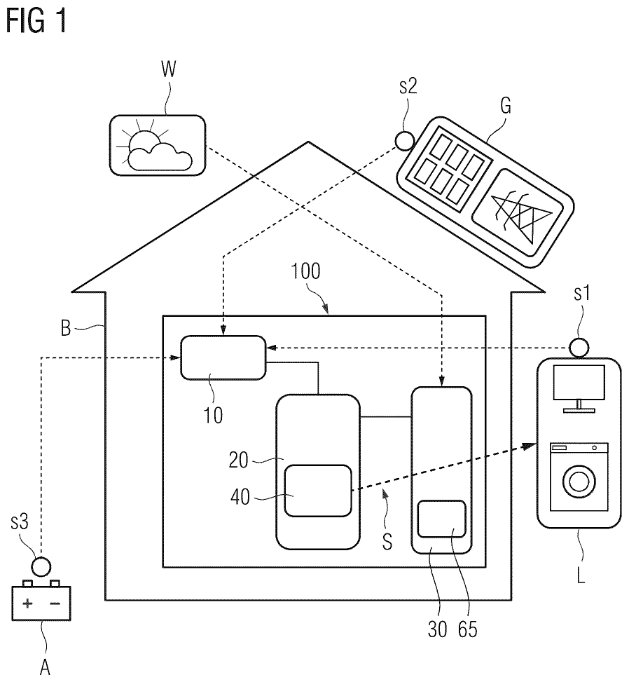

FIG. 1 shows a schematic illustration of an energy management system 100 for a building B incorporating teachings of the present disclosure. The system 100 comprises a monitoring unit 10, a management unit 20, and an optimization unit 30.

The monitoring unit 10 of the energy management system 100 is an information and communication technology device capable of acquiring data and delivering it for further processing. It is configured to acquire information about the power generated by power generation devices G, about the power consumed by the power consumption devices L (loads) and about the state of charge SoC of power storage devices A. This information is gathered from a set of sensors s1-s3 (e.g. temperature sensors) installed in the building B.

The management unit 20 of the energy management system 100 is an entity able to process information, in particular the information acquired by the monitoring unit 10. The management unit 20 is configured to derive information about a flexibility of the power demand (or demand-side flexibility) of the power consumption devices L deployed in the building B.

The optimization unit 30 of the energy management system 100 is an entity able to process information, which is configured to optimize the power allocation of the power produced by the power generation devices G to the power consumption devices L and/or to the power storage devices A. This power allocation depends on the demand-side flexibility available at the building B at any point in time.

In some embodiments, the optimization unit 30 is configured to implement an energy data model of the building together with an optimization algorithm. The algorithm incorporates a cost function, which is set to minimize a number of parameters (rather prominently CO2 production). The algorithm uses, among others, the information gathered by the monitoring unit 10, the base load of the building B, the demand-side flexibility, weather forecasts W, and information about the power supplied by the grid. An information about the power supplied by the grid can refer, e.g., to possible reductions of the power, such as the ones implemented in some demand response programs. It may also indicate the supply-side flexibility coming from the grid.

With all this information or data about the present status and future projection of the power consumption, power generation and state of charge SoC of the storage assets, the algorithm suggests a power configuration for the building B to match the solution that minimizes the cost function.

In some embodiments, the optimization unit 30 of the energy management system 100 further comprises a database unit 65, which is configured to store a historical time series of the base loads of the building B. In these embodiments, this information is also used by the algorithm in order to generate the optimal power configuration for the building B. The optimal power configuration for the building B is communicated by the optimization unit 30 to the management unit 20 through request signals.

In some embodiments, the management unit 20 is further configured to comprise a load controlling subunit 40, which is a device or a collection of devices configured to release an actuation signal S based on the request signal to a set of actuators (not shown in the figure) deployed in the building B. These actuators are devices or mechanisms able to perform mechanical work on the power consumption devices L and/or the power storage devices A. For instance, a set of actuators may be responsible for increasing the power of a heat pump, or activating electric roller shutters.

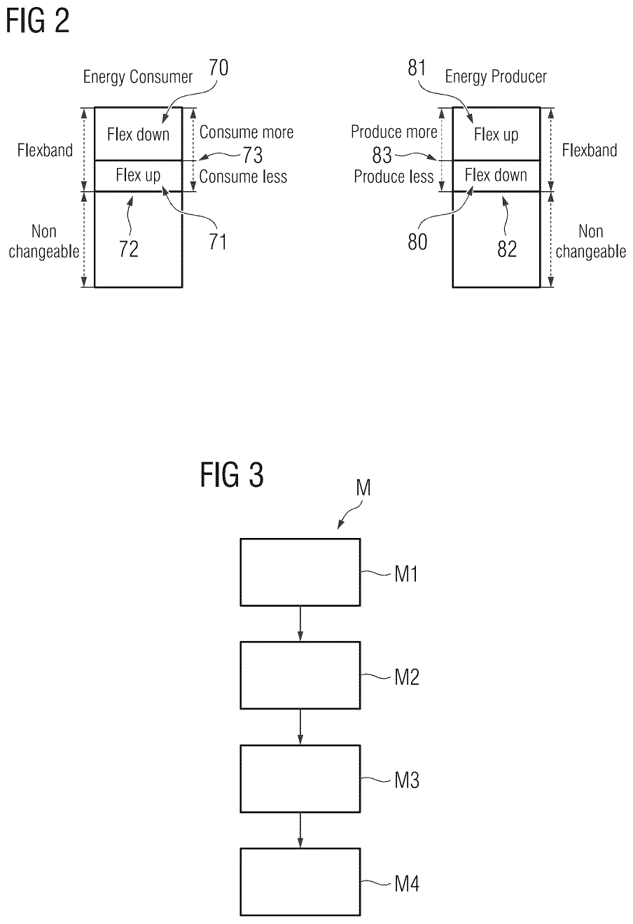

FIG. 2 shows a schematic representation of the flexibility of the power demand and the flexibility of the power generation. The horizontal bar 73 on the left panel shows the power consumption of an energy consumer, e.g. of a power consumption device L of the building B, at a moment in time. This quantity may be determined by a sensor and communicated to the monitoring unit 10.

The power band 71 shows an amount of power consumption that could be reduced by the power consumption device L. This amount is limited by the power band 72, which indicates the base load or continuous load of the power consumption device L. In other words, the power band 71 can be determined as the difference between the current power consumption 73 and the base load of the power consumption device L.

The power band 70 shows the possible power consumption increase of the power consumption device L. This can be determined by knowing the maximum power that the power consumption device L can consume. The aggregation of the power bands 70 and 71 defines the demand-side flexibility of the power consumption device L, which is derived by the management unit 20.

The horizontal bar 83 on the right panel shows the power produced by an energy producer, e.g. of a power generation device G at a moment in time. This quantity may be determined by a sensor and communicated to the monitoring unit 10.

The power band 80 shows by how much the power generation of the power generation device G could diminish. The power band 80 is limited by the power band 82, which indicates the minimum power production of the power generation device G. The power band 80 can therefore be determined as the difference between the measured current power production 83 and the minimal performance of the power generation device G.

The power band 81 shows the possible power generation increase of the power generation device G. This is determined by the difference between the current power generation and the maximum performance of the power generation device G. The aggregation of the power bands 80 and 81 defines the supply-side flexibility of the power generation device G.

FIG. 3 is a block diagram showing an exemplary embodiment of a computer-implemented energy management system method M incorporating teachings of the present disclosure, in some cases to be applied with the energy management system 100 described in FIG. 1.

A first step M1 comprises acquiring information about the power generated by the power generation devices G, about the power consumed by the power consumption devices L and about the state of charge of the power storage devices A of a building B.

In a second step M2, the demand-side flexibility of the power consumption devices L deployed in the building B is derived, based on the information acquired in step M1.

In a further third step M3, the power allocation of the power produced by the power generation devices G is optimized, based on the demand-side flexibility of the building B. This optimization splits the power generation produced by the power generation devices G into a portion to be used, i.e consumed, by the power consumption devices L and another portion to be used by the power storage devices A.

In a further fourth step M4, an actuation signal S is released to a set of actuators in the building B, which can modify the power configuration of the building B according to the optimized power allocation.

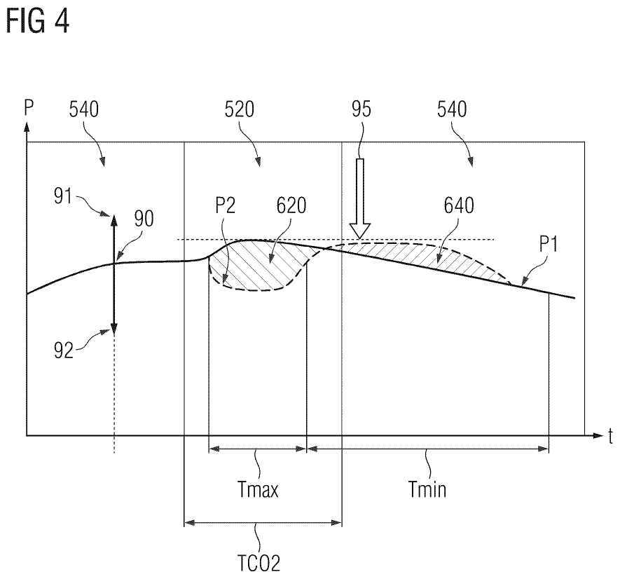

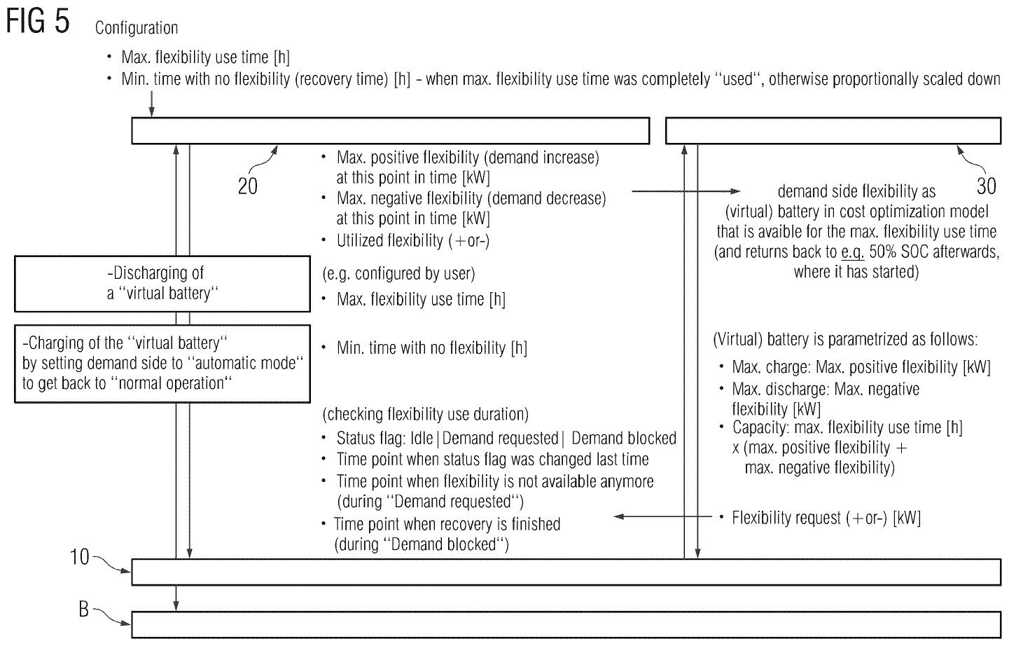

FIG. 4 is an exemplary illustration of principles of the present disclosure on a plot showing the evolution of the power consumption charge (PCC) of the building B as a function of time. The point 90 shows the PCC at a particular time, where the PCC can be acquired by the monitoring unit 10 of the energy management system 100. At that time, the demand-side flexibility is determined by the band stretching between a maximum flexibility 91 and a minimum flexibility 92. This power band is determined by the management unit 20 by aggregating the demand-side flexibility of the different power consumption devices L of the building B.

The region 540 corresponds to a time of low CO2 emission, which can be forecasted or simply measured. The region 520 corresponds instead to a time TCO2 during which the CO2 emission is high.

The curve P1 describes a possible profile for the power consumption of the building B when demand-side flexibility is not taken into account. This curve corresponds to a state-of-the-art solution. The dashed line 95 shows a power peak load. When the power consumption reaches the power peak load 95, a state-of-the-art energy management system is configured to reduce the power consumption of the building, e.g. by switching off some loads.

The curve P2 describes instead a possible energy configuration where demand-side flexibility is taken into account. The curve P2 is the result of an optimized power allocation over time produced by the optimization unit 30 and implemented by the management unit 20 via the load controlling subunit 40.

Within the region 520, in which there are high levels of CO2 emission and the power consumption is approaching a peak load 95, the optimization unit 30 generates an optimized solution which involves the demand-side flexibility of the building B. Accordingly, the power consumption coming from the grid gets reduced, avoiding the peak load 95 without having to shut down some of the power consumption devices L of the building B.

The optimization unit 30 models the demand-side flexibility of the building B as a virtual battery. The region 620 shows the capacity of the virtual battery of the building B used during the time Tmax. The time Tmax corresponds to the maximum time of use of the demand-side flexibility without interruption in a discharge cycle of the virtual battery and it can be set by a user, e.g. as a field in an interface connected to the management unit 20. It can also be set automatically by the system 100.

When Tmax has expired, the management unit 20 of the energy management system automatically switches to a default operation mode, where the power consumption coming from the grid is increased (but stays below the peak load) and is partly used to recharge the virtual battery. This corresponds to the region 640, which indicates the capacity acquired by the virtual battery in the time region 540. In this time region 540 the levels of CO2 emissions are low. Therefore, the use of the demand-side flexibility optimizes the use of energy from the grid during times of high levels of CO2 emission.

The operation of the optimization unit 30 can be restarted after a minimum waiting time Tmin, which can be set by a user through an interface connected to the management unit 20 or set automatically by the system 100 based e.g. on the time required to bring the entire building B to the default operation mode. In FIG. 4, Tmin is actually longer than the time needed to recharge the virtual battery. After Tmin is over, the demand-side flexibility can be used again according to the optimized power allocations produced by the optimization unit 30.

FIG. 5 shows a description of the features of the management unit 20 and the optimization unit 30 incorporating teachings of the present disclosure. The management unit 20 is configured to acquire information about the maximum and the minimum flexibility (see e.g. points 91 and 92 of FIG. 4). Together with the measured power consumption, the demand-side flexibility and the utilized flexibility can be determined. This information is transferred to the optimization unit 30, which models the demand-side flexibility as a virtual battery to be used to determine the optimized power allocation. The virtual battery has the maximum positive flexibility 91 as its maximum charge and the maximum negative flexibility 92 as its maximum discharge. The capacity is then the sum of the maximum positive flexibility 91 and the maximum negative flexibility 92 multiplied by the maximum flexibility use time Tmax. In some embodiments, the optimization unit 30 is further configured to send periodic requests of the available flexibility to the management unit 20.

The management unit 20 is also configured to store information about a maximum flexibility use time (Tmax in FIG. 4), i.e. the maximum time the optimization unit 30 can operate without interruption, and a minimum waiting time (Tmin in FIG. 4), i.e. the minimum time where the demand-side flexibility is not used and the system 100 runs under the default operation mode (described also as automatic mode or normal operation in the figures).

The management unit 20 may also provide information about the status of the optimization unit 30, tagged as “idle”, “demand requested” or “demand blocked”. “Idle” indicates no activity of the optimization unit 30, “demand requested” indicates that the optimization unit 30 is sending a request signal based on an optimized power allocation, while “demand blocked” goes back to the default operation mode. The management unit can also show information about the time when the status was changed for the last time, the time left until the maximum flexibility use time Tmax expires (during periods of demand requests) and the time left until the optimization unit 30 can be used again (during “demand blocked” status).

The monitoring unit 10, the management unit 20 and the optimization unit 30 are interconnected with each other and can exchange signals. In order to modify the power configuration of the building B, the management unit 20, through e.g. the load controlling subunit 40, is adapted to send actuation signals S.

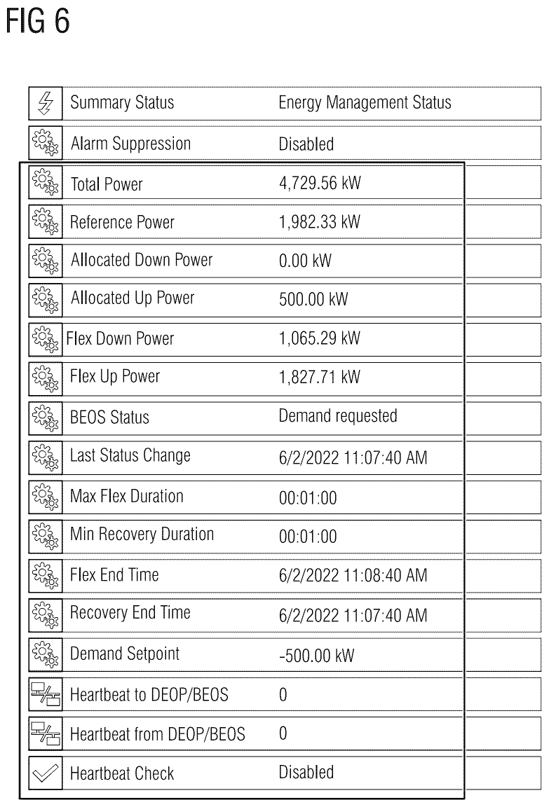

FIG. 6 shows a possible data point of the management unit 20 in an end-user interface incorporating teachings of the present disclosure. The different fields on the left-hand side correspond to the features described in FIG. 5. The total power is the power consumption charge, while the reference power is the power of those assets that can be used for flexibility. The allocated down and up power refer to the flexibility used by the system 100 (see e.g. the energy consumer drawing in FIG. 2). Both values are defined as positive. In the data point of FIG. 6 there is no allocated down power and 500 kW of allocated up power, which indicates a reduction of the consumption. Flex Down power and the Flex Up power correspond to the points 91 and 92 of FIG. 4, respectively. Their difference is the demand-side flexibility.

FIG. 6 shows a data point with a “demand request” status (noted as BEOS status). The status was changed for the last time at 11:07:40. Since the maximum flexibility use time Tmax and the minimum recovery time (or minimum waiting time Tmin) are set to 1 minute, the end of the operation time of the optimization unit 30 is at 11:08:40.

The demand request is summarized in the demand setpoint, which in this example is set at −500 kW. The heartbeat options allow to control the activity of the signal exchange between the management unit 20 and the optimization unit 30. In the example of FIG. 6, this option was disabled.

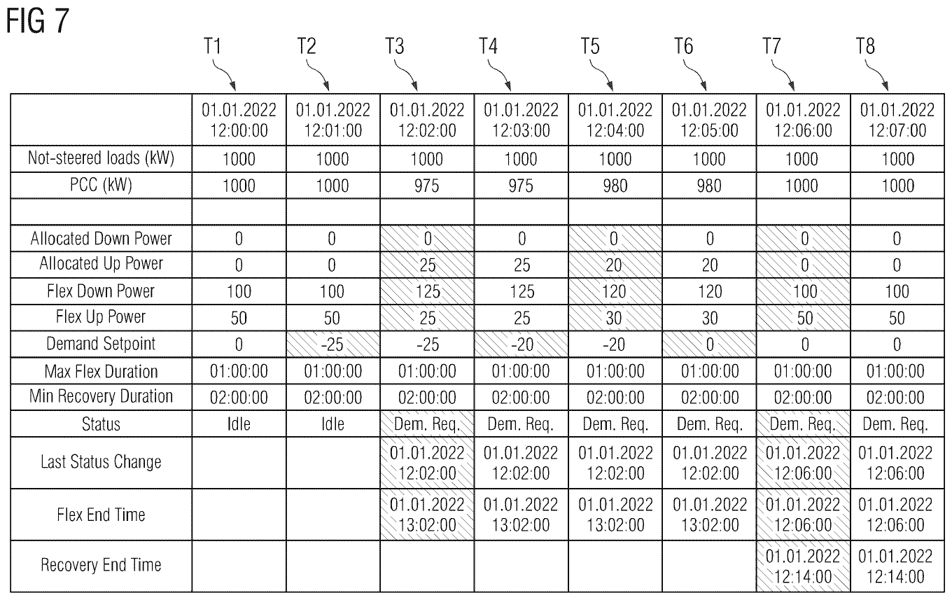

FIG. 7 is a table showing one exemplary illustration of the interaction between the management unit (20 and the optimization unit 30 upon the generation of a set of request signals. The columns noted as T1-T8 show the power configuration of the system 100 at intervals separated by 1 minute. The maximum flexibility use time Tmax is set at 1 hour and the minimum waiting time Tmin (or minimum recovery time) at 2 hours. In this example, the optimization unit 30 sends a number of requests to decrease the power consumption charge (PCC) of the building.

At time T1, the system has a power consumption charge (PCC), e.g. from the grid, which is set at 1000 kW. The demand-side flexibility shows a Flex Down Power of 100 kW and a Flex Up Power of 50 kW. There are no allocated powers at this time and the status of the optimization unit 30 is idle.

At time T2, the optimization unit 30 sends a request signal to reduce the PCC by 25 kW.

At time T3, the status is changed to “demand request” and an (up) power of 25 kW is allocated. Correspondingly, the PCC decreases from 1000 kW to 975 kW, the Flex Down Power increases by 25 kW and the Flex Up Power decreases by 25 kW. The time T3 is noted as the time of the last change of status and the end of the flexibility time is set 1 hour later than T3.

At time T4, the optimization unit 30 sends a request signal to reduce the PCC by 20 kW.

This request signal is processed at time T5 by the management unit 20. Accordingly, the PCC is set at 980 kW, i.e. the 20 kW are not cumulative but refer to the initial configuration with a PCC of 1000 kW. A 20 kW (up) power is allocated and the Flex Down and Flex Up powers are set at 120 kW and 30 kW, respectively, to account for this change.

At time T6, there is a demand request to restore the initial power configuration present at T1.

At time T7, this demand is executed and the status changed to “request blocked”. The flexibility end time is set to the time T7 and the recovery end time 8 minutes afterwards. At time T8, the power configuration is that of the system 100 at T7.

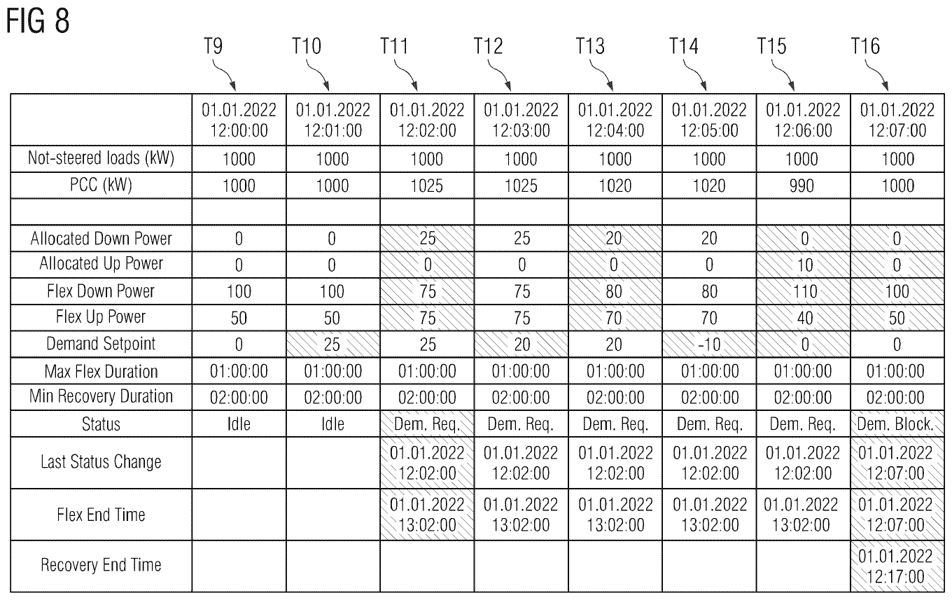

FIG. 8 is a table showing another exemplary illustration of the interaction between the management unit 20 and the optimization unit 30 upon the generation of another set of request signals. In this case, the optimization unit 30 requests to increase the PCC and then decrease it. FIG. 8 shows the power configuration of the system 100 at times T9-T16, taken at intervals of 1 minute. The maximum flexibility use time Tmax is set at 1 hour and the minimum waiting time Tmin (or minimum recovery time) at 2 hours. The rest of the initial (at time T9) power configurations are the same as in FIG. 7.

At time T10, the optimization unit 30 requests to increase the PCC by 25 kW. At time T11, the management unit 20 allocates the power change, namely the allocated (down) power is set to 25 kW, the Flex Down and Flex Up powers both to 75 kW, and the PCC is increased to 1025 kW. The flexibility end time is set at 1 hour after T11 and the status of the system 100 is set at “demand request”.

At time T12, the optimization unit 30 requests to increase the PCC by 20 kW. At time T13, the management unit 20 allocates the power change, namely the allocated (down) power is set to 20 kW, the Flex Down and Flex Up powers to 80 kW and 70 kW, respectively, and the PCC is increased to 1020 kW. The status of the system 100 is kept at “demand request”.

At time T14, the optimization unit 30 requests to decrease the PCC by 10 kW. At time T15, the management unit 20 allocates the power change, namely the allocated (up) power is set to 10 kW, the Flex Down and Flex Up powers to 110 kW and 40 kW, respectively, and the PCC is decreased to 990 kW. The status of the system 100 is kept at “demand request”.

At time T15, there is also a demand request to restore the initial power configuration present at time T9. At time T16, the demand is executed and the status changed to “request blocked”. The flexibility end time is set to the time T16 and the recovery end time 10 minutes afterwards.

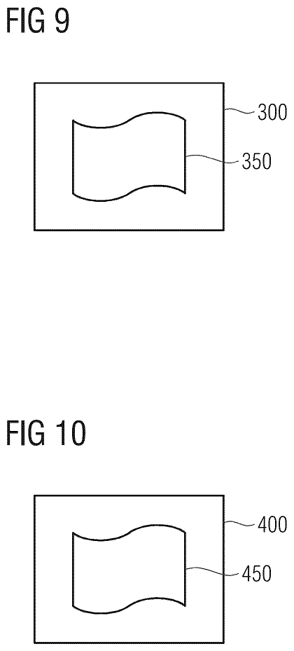

FIG. 9 shows a schematic block diagram illustrating a computer program product 300 incorporating teachings of the present disclosure. The computer program product 300 comprises executable program code 350 configured to, when executed, perform one or more of the method described herein.

FIG. 10 shows a schematic block diagram illustrating a non-transitory computer-readable data storage medium 400 incorporating teachings of the present disclosure. The data storage medium 400 comprises executable program code 450 configured to, when executed, perform one or more of the methods described herein. The non-transient computer-readable data storage medium may comprise, or consist of, any type of computer memory, in particular semiconductor memory such as a solid-state memory. The data storage medium may also comprise, or consist of, a CD, a DVD, a Blu-Ray-Disc, an USB memory stick or the like.

The previous description of the disclosed embodiments are merely examples of possible implementations, which are provided to enable any person skilled in the art to make or use the teachings of the present disclosure. Various variations and modifications of these embodiments will be readily apparent to those skilled in the art, and the generic principles defined herein may be applied to other embodiments without departing from the spirit of scope of the present disclosure. Thus, the scope of the present disclosure is not intended to be limited to the embodiments shown herein but it is to be accorded the widest scope consistent with the principles and novel features disclosed herein. Therefore, the scope of the present disclosure is not to be limited except in accordance with the following claims.

### LIST OF REFERENCE SIGNS

10 Monitoring unit
20 Management unit
30 Optimization unit
40 Load controlling subunit
65 Database unit
70-72 Power band
73 Power consumption
80-82 Power band
83 Power production
90 Power consumption
91 Maximum flexibility
92 Minimum flexibility
95 Power peak load
100 Energy management system
300 Computer program product
350 Executable program code
400 Non-transient computer-readable data storage medium
450 Executable program code
520 Time region of high CO2 emissions
540 Time region of low CO2 emissions
620 Capacity used by the virtual battery
640 Capacity acquired by the virtual battery
A Power storage devices
B Building
G Power generation devices
L Power consumption devices
M Energy management method
M1-M4 Method steps
P1-P2 Power consumption profiles
S Actuation signal
s1-s3 Sensors
TCO2 Time of high CO2 emissions
Tmax Maximum flexibility use time
Tmin Minimum waiting time
T1-T16 Time points
W Weather forecast

What is claimed is:

1. An energy management system for a building having power consumption devices, power generation devices, and power storage devices, said system, comprising:
a monitoring unit to acquire information about power generated by the power generation devices, about power consumed by the power consumption devices, and about a respective state of charge of the power storage devices;
a management unit to derive information about a flexibility of the power demand of the power consumption devices deployed in the building based on the information acquired by the monitoring unit; and
an optimization unit to optimize the power allocation of the power produced by the power generation devices to the power consumption devices and/or to the power storage devices based at least in part on the derived flexibility information of the power demand.

2. The system according to claim 1, wherein the optimization unit sends request signals based on the optimized power allocation to the management unit.

3. The system according to claim 2, wherein the management unit comprises a load controlling subunit to release an actuation signal based on a received request signal to a set of actuators deployed at the building.

4. The system according to claim 1, wherein the management unit implement a default operation mode defined by a set of predetermined values of power consumption and power generation of the building.

5. The system according to claim 1, wherein the management unit set a minimum waiting time, during which the optimization unit does not send request signals and the energy management system runs under a default operation mode.

6. The system according to claim 1, wherein the management unit sets a maximum flexibility use time for the optimization unit to operate without interruption.

7. The system according to claim 6, wherein the management unit switches to a default operation mode, when the maximum flexibility use time of operation of the optimization unit has expired.

8. The system according to claim 1, wherein the optimization unit implements an energy data model of the building and an optimization algorithm, wherein the data model uses forecasts of the power generation and forecasts of the power demand of the building as well as the acquired data as input.

9. The system according to claim 8, wherein the optimization algorithm uses as input information at least a weather forecast and/or information about the power supplied by a power supply grid providing electrical energy to the building.

10. The system according to claim 8, wherein the optimization unit comprises a database unit to store a base load time series of the building, and wherein the optimization algorithm retrieves the base load time series to use it as input.

11. The system according to claim 1, wherein the management unit and/or the optimization unit are implemented in a server or as part of a cloud platform.

12. The system according to claim 1 wherein the optimization unit requests the derived information about the flexibility of the power demand no more often than every 10 seconds.

13. The system according to claim 1, wherein the flexibility of the power demand is communicated to the optimization unit in an aggregated way, and wherein the optimization unit models the flexibility of the power demand as a virtual battery.

14. A energy management method for a building:
acquiring information about the power generated by power generation devices in the building, the power consumed by power consumption devices in the building, and a respective state of charge of power storage devices in the building;
deriving information about a flexibility of a power demand of the power consumption devices deployed in the building based on the acquired information; and
optimizing a power allocation of the power produced by the power generation devices to the power consumption devices and/or to the power storage devices depending on the derived flexibility information of the power demand.

15-16. (canceled)
